(19) United States
(12) Patent Application Publication
(10) Pub. No.: US 2024/0069191 A1
(43) Pub. Date: Feb. 29, 2024

(54) SYSTEM FOR CONTROLLING A SOUND-BASED SENSING FOR SUBJECTS IN A SPACE

(71) Applicant: SIGNIFY HOLDING B.V., EINDHOVEN (NL)

(72) Inventors: PETER DEIXLER, ARLINGTON, MA (US); JIN YU, LEXINGTON, MA (US)

(21) Appl. No.: 18/271,077

(22) PCT Filed: Jan. 3, 2022
(86) PCT No.: PCT/EP2022/050007

§ 371 Date: Jul. 6, 2023

Related U.S. Application Data
(60) Provisional application No. 63/134,752, filed on Jan. 7, 2021.

(30) Foreign Application Priority Data
Feb. 16, 2021 (EP) 21157454.6

(51) Int. Cl. G01S 15/04; G01S 15/87; G01S 15/89

(52) U.S. Cl. CPC G01S 15/04; G01S 15/876; G01S 15/89

(57) ABSTRACT

The present invention refers to a system (110) for controlling a sound-based sensing of subjects (120) in a space, wherein the sensing is performed by a network (100) of network devices (102,103,104) distributed in the space. At least one network device comprises a generating unit and a plurality of network devices located differently from the generating unit comprising a detecting unit. The system comprises a controlling unit (111) for controlling the at least one generating unit to generate a predetermined sound and the plurality of detecting units to detect the sound after a multi-channel propagation through at least a portion of the space and to generate a sensing signal indicative of the detected sound, and a determination unit (113) for determining a status and/or position of at least one subject in the space based on the plurality of sensing signals.

### FIELD OF THE INVENTION

The invention relates to a system, a method and a computer program for controlling a sound-based sensing of subjects in a space and further relates to a network comprising the system.

### BACKGROUND OF THE INVENTION

Position and/or status detection of indoor objects such as office desks, chairs, doors and windows, has a wide variety of applications. Door and window status change detection is useful for intruder detection, optimized HVAC control, and even daily activity monitoring of independently living elderly people. Similarly, monitoring the position of furniture is valuable for space optimization applications such as used in commercial offices with flex-desks and meeting rooms.

Current state of the art solutions for monitoring door and window status in a home or an office building include cameras and wireless contact-closure sensors. Audio-based event recognition has also been used for home security monitoring to flag intruders forcefully entering through a door or window by monitoring passively sound events in the environment. For example, known systems with on-board microphone sensors use artificial intelligence algorithms to listen and recognize an event like a door or window being broken open. However, prior art approaches for guarding the home with audio analytics either need cloud computing or an expensive edge device capable of running a deep learning neural network. In addition, for full building coverage many devices distributed across the premise might be needed. In addition, the audio-based prior art guarding technology is only able to listen passively to noise status change events occurring rather than continuously sensing for the current status of a door or window. Hence, in practise, even advanced audio analytics solutions have to be still complemented with wireless contact closure sensors to determine with certainty whether a door or window has been unintentionally left open.

Besides security considerations, the status of a door or window is also closely related to energy efficiency. An open door or window reduces the building's HVAC energy efficiency, especially in extreme weather. Hence, it is desired that the user is notified about unexpected door and window status changes.

Current state of the art for detecting position of changeable furniture, like desks or chairs often includes battery-operated beacons or tags being mounted on each piece of furniture and a real time location system to recognize and report changes in furniture arrangement, e.g. to the cloud-based space optimization system. However, real time location systems are expensive and the beacons or tags suffer from a short battery life, e.g. lower than 2 years. Hence, a method is desired which keeps track of changes to the furniture layout in the office room without requiring a real time location system. More generally, it is desired to provide a system that allows for an accurate and reliable detection of status changes of subjects in a space.

### SUMMARY OF THE INVENTION

It is an object of the present invention to provide a system, a network comprising the system, a method and a computer program product that allow to increase the accuracy and reliability of sensing a status of objects in a space. Moreover, it is preferred that the system, the network comprising the system, the method and the computer program product also allow for an accurate and reliable detection of activities of living beings in a space.

In a first aspect of the present invention a system for controlling a sound-based sensing of subjects in a space is presented, wherein the sensing is performed by a network of network devices, wherein at least one network device comprises a sound generating unit and a plurality of network devices comprising each a sound detecting unit, wherein the network devices are distributed in the space, wherein the system comprises a) a sound generation controlling unit for controlling the at least one sound generating unit to generate a predetermined sound and for controlling the plurality of sound detecting units to detect the sound after a multi-channel propagation through at least a portion of the space and to generate a sensing signal indicative of the detected sound, wherein the at least one sound generating unit is located at a position in the room different from the position of the sound detecting units in the room, and b) a subject determination unit for determining a status and/or position of at least one subject in the space based on the plurality of sensing signals.

The system further comprises a baseline providing unit for providing a baseline indicative of sensing signals detected by the sound detecting units with respect to at least one predetermined status and/or position of the at least one subject in the space, wherein the subject determination unit (113) is adapted to determine a status and/or position of the at least one subject further based on the provided baseline; wherein a plurality of the network devices comprises a sound generating unit; wherein the sound generation controlling unit is adapted to control the sound generating units of the network devices to subsequently generate a predetermined sound and the sound detecting units of all other network devices to detect the subsequently generated sounds. In embodiments, said system may be a lighting system, and said network devices may be lighting devices and/or luminaires.

Since the sound generation controlling unit is adapted to control the sound generating unit to generate a predetermined sound and also to control the sound detecting units to detect the sound after a multi-channel propagation through at least a portion of the space, an active detection can be provided that allows for actively sensing status changes of subjects in the space. Moreover, since the status and/or position of a subject in the room is determined by the subject determination unit based on the plurality of sensing signals that result from the sound detection of the sound detecting units that are not located at the same position as the sound generating unit, reflections of the generated sound in a plurality of directions in the space can be taken into account for determining the status and/or position of the subject. This allows for a more accurate detection of the status and/or position of the subject compared with systems that only use sound signals that result from reflections back to the device that has sent the sound. Thus, the system allows for a more accurate and reliable sensing of the status and/or position of objects and/or living beings in a space.

The network of network devices which can also be understood as a sensing network comprises at least three network devices, in particular, at least one network device which is adapted to generate a sound and at least two network devices that are adapted to detect a sound. Preferably, the network comprises more than three network devices, wherein the number of network devices in the network can be adapted based on the space in which a sensing should take place. For example, the larger the space the more network devices can be provided in the network and/or the more complex a shape of the space the more network devices can be provided in the network. Preferably, all network devices comprise a sound generating unit and are thus adapted to generate sound, and a sound detecting unit and are thus adapted to detect sound. However, the network can also comprise one or more network devices that are dedicated to generate a sound and thus only comprise a sound generating unit and two or more network devices that are dedicated to detect a sound and thus comprise only a sound detecting unit. Generally, a network device can be regarded as any device adapted to form a network with other network devices. In particular, a network device comprises a network device communication unit that is adapted to receive and transmit wired or wireless signals, for instance, radiofrequency signals, infrared signals, electrical signals, etc. The network between the network devices can then be formed through a communication between the network devices following a known network communication protocol like WiFi, ZigBee, Bluetooth, etc. Preferably, the network devices refer to smart devices, i.e. devices comprising a communication unit for receiving and transmitting network communication signals but which otherwise fulfil the function of a corresponding conventional device. In particular, such a smart device can be a smart home or office device, in which case the corresponding conventional function would be that of a conventional home or office device. Preferably, the conventional function refers to a lighting function and the network devices refer to network lighting devices that are further adapted to comprise a sound generating unit and/or a sound detecting unit. However, the network devices can also refer, for instance, to smart plugs, smart switches, etc.

The system can be part of the network, for instance, can be part of one or more of the network devices. In particular, the system can be provided as hard- and/or software as part of one of the network devices or distributed over a plurality of the network devices that are in communication with each other to form the system. However, the system can also be provided as a standalone system, for instance, in a device that is not part of the network of network devices but is directly or indirectly in communication with at least one of the network devices, for instance, to control the network devices. For instance, the system can be provided as part of a handheld computational device like a smartphone, a tablet computer, a laptop etc. However, the system can also be located in a cloud formed by one or more servers, wherein in this case the system might communicate with the network, in particular, the network devices, via one or more devices that are connected to the cloud like a router.

The subject for which a status and/or position should be determined can be any animate or inanimate subject. In a preferred embodiment, the subject refers to an object, in particular, to an object being part of a room setup like a door, window, table, chair or other furniture. In this case, a status of the subject can refer to an open or closed status, to an occupied or unoccupied status, to a functional status, etc. However, additionally or alternatively, the subject can also refer to a living being like a human or an animal that can be present in the space. In this case, the status of the subject can refer, for instance, to a presence or absence status, to a movement status, to an activity status like working, sleeping, moving etc. Moreover, the status can also refer to a size of the subject, and/or to a direction and/or speed of movement of the subject. For example, it can be determined based on the size if an adult or a child is present in the area. The space in which the sensing of the status and/or position of the subject is performed can refer to any space. Preferably, the space refers to a closed space like an indoor area or a room. However, in other embodiments, the space can also refer to an open space like a garden or other outdoor area. The space can also refer to an open space indoors, for instance, to an open area within a room like a couch area, a kitchen area, etc. Generally, the space in which the sensing can be performed is determined by the distribution of the network devices and the possible propagation paths between the sound generating unit and the respective sound detecting units.

The sound generation controlling unit is adapted to control the at least one sound generating unit, in particular, to control a network device comprising the sound generating unit, to generate a predetermined sound. The predetermined sound can generally refer to any sound that can be provided by the sound generating unit and comprises a predetermined characteristic like a predetermined length, a predetermined frequency spectrum, a predetermined amplitude, etc. Preferably, the sound generation controlling unit is adapted to select a predetermined sound from a plurality of predetermined sounds that are provided, for instance, in form of a list, wherein the selection can be based on the intended application of the system. For example, if the system shall be applied to a security monitoring during times in which no persons are present in a room, the predetermined sound can be selected such that it is suitable for this application and may comprise characteristics that are not desirable in the presence of persons in the room. For example, the predetermined sound can comprise a higher amplitude or a different frequency than a predetermined sound that is utilized when persons are present in the room. In particular, if the system shall be applied for sensing living beings as subjects, it is preferred that the predetermined sound being optionally a selected predetermined sound is substantially not perceptible as sound used for sensing by the living being. For example, the predetermined sound can be provided as part of an overall acoustic environment such that the predetermined sound can only be perceived as part of this overall acoustic environment. Exemplarily, the predetermined sound can be provided as part of a piece of music or adapted to a piece of music played in the space. Moreover, the predetermined sound can be provided as white noise or can be provided in a frequency range that is not perceptible by a human being. Generally, the predetermined sound can be selected or adapted based on knowledge on a current situation. For example, if it is known, for instance, from other sensors in the space, that an elderly person is present, the predetermined sound can be selected or modified to refer to a frequency range that is not perceivable by an elderly person, for instance, a frequency range above 18 kHz.

Further, the sound generation controlling unit is adapted to control the plurality of sound detecting units, in particular, the plurality of network devices comprising the sound detecting units, to detect the sound after a multi-channel propagation through at least a portion of the space. Generally, a sound generating unit and a sound detecting unit can be regarded as a sound propagation pair between which the sound generated by the sound generating unit propagates in a multipath transmission channel from the sound generating unit to the sound detecting unit. An audio multipath transmission channel can be, for instance, three-dimensional and shaped such that it is narrow at the point of the sound generation, wide during the propagation through the space and again narrow at the point of the detection by the sound detecting unit. However, the exact shape of an audio multipath transmission channel is determined by the environment, in particular, the space, through which the sound propagates. Generally, an audio multipath transmission channel can be regarded as comprising multiple audio paths due to the different reflections of the generated sound on one or more surfaces. For instance, one of the multiple audio paths may refer to the sound being reflected by a table before detection, one may refer to a direct path between the generation and the detection, and one may refer to the reflection from a wall before the detection. Since the sound is generated by one sound generating unit and then detected by a plurality of sound detecting units, different, i.e. multiple, channels comprising again multiple audio paths can be exploited during the sensing. Thus, the propagation of the sound after the generation refers to a multi-channel propagation, wherein each detecting unit detects one of the multi-channels as detected sound. Based on this detected sound, the sound generation controlling unit is then adapted to control the detecting units to generate a sensing signal that is indicative of the detected sound. The sensing signal can refer, in particular, to an electrical signal that is indicative of the detected sound.

The subject determination unit is then adapted to determine a status and/or position of at least one subject in the room based on the plurality of sensing signals. Since the sound generated by the sound generating unit propagates in a multi-channel propagation through the space to the sound detecting units, each of the multi-channels and thus each of the sensing signals comprises information on the propagation path the sound has taken in the room, for example, whether the sound has been reflected by an object on one or more of the paths. The subject determination unit can thus use this information provided by the sensing signal to determine a status and/or position of at least one subject in the space.

Generally, the subject determination unit can be part of software and/or hardware of one of the network devices. However, the subject determination unit can also be part of software and/or hardware of other devices that are communicatively coupled with the network. For example, the subject determination unit can be part of the software and/or hardware of a gateway featuring a Linux microcontroller, hence comprising more computational power that typically present in a network device.

The sensing signals utilized by the subject determination unit are indicative of the detected sound during a predetermined time period of, for instance, a few seconds. Thus, the sensing signals refer generally not to one value, but to a continuous measurement of the detected sound during the predetermined time period. The time period can, for instance, be determined by the length of the predetermined sound that is generated by the sound generating unit and the measurement of the detected sound can start, for instance, at the same time at which the sound generating unit starts to generate a predetermined sound. In particular, in small spaces the travel time of the sound between the sound generating unit and the sound detecting unit can be neglected. However, in some cases and in particular for wide, open areas a short delay can also be taken into account before starting the measurement. However, in other embodiments the detecting unit can also be adapted to generate the sensing signal in a moving time window, i.e. by continuously detecting the sound and generating the sensing signal for time periods with the predetermined length continuously.

In an embodiment, the subject determination unit can be adapted to utilize a machine learning algorithm to determine a status and/or position of at least one subject in the space based on the plurality of sensing signals. For example, a known machine learning algorithm can be provided and then trained after the installation of the system and the network devices in a space. For training, a sound-based sensing can be performed, i.e. the sound generation controlling unit can be adapted to control the sound generating unit to generate the predetermined sound and the sound detecting unit to detect the sound and to generate the sensing signal, for the different statuses and/or positions that should be identified and thus determined by the subject determination unit. For example, if an open or closed status of a window shall be determined by the subject determination unit, a sound-based sensing can be performed first for the closed status of the window and second for the open status of the window and preferably also for some positions in between, for instance, for a half opened window. The sensing signal for each of these statuses can then be provided as training data to the machine learning algorithm together with the corresponding status of the window for which the sensing signals have been determined. Based on known training processes, the machine learning algorithm can then learn to differentiate between an open and a closed status of the window based on the sensing signals. The such trained machine learning algorithm can then be utilized by the subject determination unit for determining the status of the window for each new sound-based sensing. However, the subject determination unit can also be adapted to utilize other methods for determining the status and/or position of the at least one subject in the space based on the plurality of sensing signals, as will be described, inter alia, in the following.

In an embodiment, the status and/or position is determined based on i) the signal strength of the plurality of detected sensing signals and/or based on ii) channel state information derived from the plurality of detected sensing signals and the predetermined generated sound. With respect to the first option, the subject determination unit is adapted to determine a status and/or position of at least one subject in space based on the signal strength of the plurality of detected sensing signals. Since a signal strength of the sensing signal depends on an amplitude of the sound that directly or indirectly reaches the sound detecting unit, the single strength is indicative of the different paths the sound can travel from the sound generating unit to the sound detecting unit. Since these paths are highly dependent on the environment between the sound generating unit and the sound detecting unit and thus also dependent on the position and/or status of subjects in the environment, the signal strength is indicative of these positions and/or statuses. Moreover, since the signal strength of a plurality of detected sensing signals is utilized, wherein the sensing signals result from the detection of sound detecting units arranged at different locations, information on the environment of the network devices from a plurality of different sound paths is provided by the sensing signals.

The subject determination unit can be adapted to determine the status and/or position of the at least one subject based on the signal strength of the plurality of detected sensing signals by utilizing a machine learning algorithm, for instance, as already explained above, wherein for this case the machine learning algorithm is provided with the signal strength of the plurality of detected sensing signals and is trained to determine the status and/or position of the at least one subject from the signal strength. For training the machine learning algorithm a similar method as explained above can be utilized, in particular, the statuses and/or positions that should be identifiable for the machine learning algorithm are trained by providing corresponding signal strength training measurements to the machine learning algorithm. However, the subject determination unit can also be adapted to use other algorithms for determining the status and/or position based on the signal strength.

In the second option, the subject determination unit is additionally or alternatively adapted to determine a status and/or position of at least one subject in space based on channel state information derived from the plurality of detected sensing signals and the determined generated sound. The channel state information is indicative of the properties of a path that the sound has taken from the sound generating unit to the sound detecting unit and thus describes how the sound has propagated from the sound generating unit to the sound detecting unit. Accordingly, the channel state information is also indicative of an interaction of the sound with the subject along the propagation path. Thus, the channel state information provides very accurate information on the environment of the network with which the sound has interacted, for instance, from which it has been reflected, scattered or absorbed. Since the predetermined generated sound is known and can be communicated to the subject determination unit due to the network characteristics of the network, the channel state information can be derived from the sensing signals and the predetermined generated sound. Generally, the channel state information can be derived from the following formula:

y=Hx+n,

wherein y refers to a vector comprising the plurality of sensing signals, x refers to a vector comprising the generated predetermined sound, H refers to the channel state matrix comprising the channel state information for each channel, i.e. path, that has been taken by the sound from the sound generating unit to the sound detecting unit, and n refers to a noise vector that can be modeled in accordance with known noise models. Based on this general functional relationship, known methods can be used to determine the channel state information, i.e. the channel state matrix. In accordance with the above description with respect to the first option referring to a signal strength, the subject determination unit can also be adapted to utilize a machine learning algorithm for determining based on the determined channel state information the status and/or position of the at least one subject. In particular, a machine learning algorithm can be trained based on training channel state information corresponding to the channel state information determined for each status and/or position of the subject that should be identified by the subject determination unit. The trained machine learning algorithm can be then utilized for determining based on the derived channel state information a respective status and/or position of the at least one subject.

Generally and with respect to both options described above, as mentioned before, the system further comprises a baseline providing unit for providing a baseline indicative of sensing signals detected by the sound detecting units with respect to at least one predetermined status and/or position of the at least one subject in the space, wherein the subject determination unit is adapted to determine a status and/or position of the at least one subject further based on the provided baseline. The baseline providing unit can refer to a storage unit on which the baseline is already stored and from which the baseline providing unit can retrieve the baseline for providing the same. Moreover, the baseline providing unit can also be connected to a storage unit on which the baseline is stored. Moreover, the baseline providing unit can also refer to an input unit into which a user can input a baseline, for instance, by connecting a portable storage unit to the baseline providing unit, wherein the baseline providing unit will then provide the baseline in accordance with the input of a user. In particular, a baseline refers to the sensing signals that are indicative of the sound detected by each of the sound detecting units during a baseline measurement in which a status and/or position of the subject that should later be determined by the subject determination unit is provided in the space. For example, if the subject determination unit shall later determine whether a window is closed or open in the space, a baseline can be determined by first closing the window and then generating a sensing signal for the closed window as baseline and afterwards opening the window and then generating a sensing signal corresponding to the opened window as baseline for the opened window. The such determined baseline corresponding to different statuses and/or positions of the subject can then be used by the subject determination unit to determine from the current sensing signals if the subject is in the status and/or position to which one of the baselines corresponds. In particular, the baseline can be provided as additional input to a machine learning algorithm that has been trained accordingly. Alternatively, the subject determination unit can be adapted to compare current sensing signals with the baseline, for instance, utilizing the signal characteristics of the sensing signals and the baseline, like maximum or minimum amplitude, amplitude development, frequency spectrum, etc. The subject determination unit can then be adapted to determine whether the sensing signal corresponds to the baseline within a predetermined measure, i.e. whether the signal characteristics of the sensing signal are within a predetermined range around the signal characteristics of the baseline. If this is the case, the subject determination unit can be adapted to determine that the sensing signal corresponds to the baseline and that thus the subject has the status and/or position to which the baseline corresponds. The baseline can also refer to signal strength or channel state information measurements as described above.

In an embodiment, the sound generation controlling unit is adapted such that the sound generating unit generates the predetermined sound as a directed sound, wherein the directed sound is directed to the at least one subject. Generating a directed sound has the advantage that the influence of other subjects that should not be detected can be minimized. Moreover, also the influence of the general environment like, for instance, walls, a ceiling or a floor on the detected sound can be minimized. For example, if an open or closed status of a window shall be detected, the sound generation controlling unit can be adapted to control a sound generating unit such that it generates the predetermined sound as directed sound directed to the window such that an influence, for instance, of a table or a door near the window is minimized. Moreover, if a direct line of sight from the sound generating unit to the subject is obstructed, the directed sound can also be directed to a flat surface in the room such that the reflection of the flat surface reaches the subject. In such an embodiment, it is preferred that the flat surface does not often change its status and position such that a change in the sensing signal is only indicative of a change of the subject and not a change of the flat surface that also lies in the signal path. For generating the directed sound any known methods can be employed. For example, the sound generating device can be adapted to comprise a speaker array with a plurality of sound generating speakers that allow to direct the sound generated by the speaker array based on an interference of the sound generated by each individual speaker.

In an embodiment, the sound generation controlling unit is adapted such that the sound generating unit generates the predetermined sound as an omnidirectional sound. Generating the predetermined sound as omnidirectional sound has the advantage that a status and/or position of the whole environment of the network can be taken into account. For example, if not only the status and/or position of one object shall be determined, but the positions and/or statuses of a plurality of objects like the statuses and/or positions of a table and a plurality of chairs in a seating area, the generated omnidirectional sound allows the sound to interact with all of the objects in the environment and thus to transport the information of the statuses and/or positions of the objects to the sound detecting unit.

Preferably, the sound generation controlling unit is adapted to select whether a sound generating unit generates the predetermined sound as omnidirectional sound or as directed sound based on a desired application and/or based on a predetermined set of rules. Such rules can refer, for instance, to information and/or measurements of the environment of the network. For example, the information can indicate that during a day time the system shall be used for monitoring a status of a seating area in an office building, whereas during a night time the system shall be applied as security system. Thus, based on this information the sound generation controlling unit can be adapted to control the sound generating unit to generate the predetermined sound as an omnidirectional sound at day time and to generate the predetermined sound as a directed sound, for instance, directed to a door and/or windows of the seating area at night time. However, also other information or general knowledge on the application and environment of the system can be used for generating the rules for the sound generation controlling unit for the selection of the predetermined sound.

In an embodiment, the subject determination unit is adapted to provide weights to the plurality of sensing signals based on a predetermined sensitivity of each detected sensing signal to the influence of a status and/or position of the at least one subject and to determine the status and/or position based on the weighted sensing signals. The sensitivity of the detected sensing signals to the influence of a status and/or position of the at least one subject can be determined, for instance, during a calibration of the sensing system. For example, for different statuses and/or positions that are desired to be sensed by the sensing system a sound sensing by the sensing system can be performed and the resulting sensing signals can be compared to determine if one or more of the sensing signals are not substantially influenced by a status change and/or position change, whereas other sensing signals may show a huge difference when the status and/or position of the subject is changed. For example, the opening or closing of a window may not have an influence on some of the sensing signals but may influence other sensing signals very strongly. In this case, the sensing signals that are not substantially influenced by the status of the window can be provided by the subject determination unit with lower weights than the sensing signals that are strongly influenced. For example, sensing signals that are substantially not influenced can be provided with a weight between 0 and 0.5, whereas sensing signals which show an influence are provided with weights between 0.5 and 1. This allows to focus the analysis of the sensing signals for the determination of the status and/or position of the subject on the sensing signals that carry the most information on the status and/or position of the subject and also allows to decrease the influence of disturbances that have nothing to do with the status and/or position of the subject. Moreover, providing weights to the plurality of sensing signals as described above allows also to adapt the sensing system to different sensing situations. For example, in a situation in which the sensing system shall be applied for monitoring a sleeping person, in particular, to detect a breathing motion of the sleeping person, a different weighting may be advantageously applied than in a situation in which persons are monitored that are animatedly discussing and thus showing major motions. In some situations, the weights can also be used to increase an accuracy of the sound sensing by setting the weights of some sensing signals to zero. For example, in a situation an open door or window may influence at least one of the sensing signals, for instance, due to a bleeding out of the sound through the open door or window. In this case, after having determined that the door or window is open, the subject determination unit can be adapted to provide a lower weight, preferably a zero weight, to sensing signals, i.e. multipaths, that refer to the open window or door, in order to increase a sensing accuracy in other areas of the space away from the door or window. Also for such different situations a calibration can be performed for determining the optimal weights for the sensing signals in accordance with the actual setup of the network and the different situations, wherein the calibration results can then be stored, in particular, the weights determined during the calibration, as different modes and can then be selected by the subject determination unit.

In an embodiment, each sound detecting unit comprises a sound detection array such that the plurality of sensing signals are each indicative of a direction from which the detected sound has reached the detection array, wherein the subject determination unit is adapted to determine the status and/or position of the subject further based on the direction information provided by each sensing signal. In particular, a sound detection array allows to more accurately determine which path the sound has propagated from the sound generating unit to the sound detecting unit and, in particular, to differentiate between these different paths. This allows for a more accurate determination of the status and/or position of an object. In particular, when determining the status of a person in the space using the direction information can be advantageous. For example, the subject determination unit can be adapted to utilize the direction information to determine a sound signal that is suitable for detecting a breathing signal of a person present in the space. For determining the direction information using a detection array any known methods can be utilized by the subject determination unit.

For example, a method in accordance with the principles described in the article “Beamforming with a circular array of microphones mounted on a rigid sphere”, by E. Tiana-Roiga, et al., The Journal of the Acoustical Society of America, 130:3, 1095-1098 (2011), can be employed.

In an embodiment, each network device comprises a sound detecting unit and a sound generating unit, wherein the sound generation controlling unit is adapted to control the sound generating units of the network devices to generate a predetermined sound and the sound detecting units of all other network devices to detect the generated sounds such that for each sound generated by a different sound generating unit a plurality of detected sensing signals are generated, wherein the status and/or position of the subject is determined based on each of the plurality of audio sensing signals.

As mentioned, the sound generation controlling unit is adapted to control the sound generating units of the network devices to subsequently generate a predetermined sound and the sound detecting units of all other network devices to detect the subsequently generated sounds. In particular, the sound generation controlling unit can be adapted to control a first network device, i.e. sound generating unit of the first network device, to generate a predetermined sound and to control all other network devices, i.e. the detecting units of all other network devices, to detect the generated sound of the first network device to generate a sensing signal corresponding to the first generated predetermined sound. Then, the sound generation controlling unit is adapted to control a second network device to generate a predetermined sound and all other network devices to detect the predetermined sound to generate the sensing signals that correspond to the second generated predetermined sound and so on until all network devices have at least once generated a predetermined sound. The subject determination unit is then adapted to determine a status and/or position of the at least one subject in space based on all sensing signals, wherein also in this case, for example, the already above described methods for determining the status and/or position of the subject based on each of the plurality of audio sensing signals can be utilized. The time series of different predetermined sounds generated by different sound generating units can be similar or can be different to each other. Said term subsequently may in alternative aspects be used as consequently throughout the application.

In aspects, the sound generation controlling unit may be adapted to determine a detection time period, and control, within and/or during the detection time period, the sound generating units of the network devices to subsequently generate a predetermined sound and the sound detecting units of all other network devices to detect the subsequently generated sounds. Hence, during a determined detection time period, the system may cause the predetermined sound to be generated subsequently by the sound generating units, so as to improve detection from a multitude of sound generation locations that orchestrate their generation of the predetermined sound.

In aspects, the sound generation controlling unit may be adapted to control, at least one iteration of subsequent operation and within and/or during the detection time period, the sound generating units of the network devices to subsequently generate a predetermined sound and the sound detecting units of all other network devices to detect the subsequently generated sounds.

In another preferred embodiment, the sound generation controlling unit is adapted to control the sound generating units to generate different predetermined sounds concurrently and the sound detecting units of all other network devices to detect the different generated sounds such that a sensing signal for each different predetermined sound is generated by the sound detecting units. The different predetermined sounds preferably refer to sounds lying within different frequency ranges. For example, the sound generation controlling unit can be adapted to control a first sound generating unit to generate a first sound with a first frequency, and at the same time a second sound generating unit to generate a second sound with a second frequency. If the first and second frequency are chosen to lie within sufficiently different frequency ranges, the two detected sounds can be separated by the sound detecting units to generate different sensing signals for the different predetermined sounds. Thus, sensing signals referring to different combinations of sound generating units and sound detecting units can be sensed at the same time. Moreover, the above described embodiments can also be combined. In such an embodiment, the sound generation controlling unit is adapted to control the sound generating units of the network devices to subsequently generate different predetermined sounds and the sound detecting units of all other network devices to detect the subsequently generated different sounds. In particular, in situations in which for different combinations of sound detecting units and sound generating units different frequencies are of interest for determining a status and/or position of a subject, such a combination can be advantageous. For example, in an embodiment, based on the setup of the sensing space referring, for instance, to a room, and/or based on in which part of the space which type of sensing is desired, it can be suitable for the determination of the status and/or position of one or more subjects in the space to utilize only certain frequencies for certain sound generating unit and sound detecting unit combinations. For instance, for just coarse motion sensing, low audio frequencies suffice, while for minute breathing detection higher audio frequencies with shorter wavelength and physical proximity of the sound generating unit and sound detecting unit are required. In a more detailed example, a combination of a first sound generating unit and a third and fifth sound detecting unit with a predetermined sound at a first frequency are of interest. Moreover, a combination between a second sound generating unit and a first, the third and a forth sound detecting unit with a predetermined sound at a second frequency are of interest. In this case, when it is the turn of the second sound generating unit to generate the predetermined sound, the sound generation controlling unit is adapted to control the second sound generating unit such that it only generates the predetermined sound with the second frequency. However, when it is the turn of the first sound generating unit to generate the predetermined sound, the sound generation controlling unit can be adapted to control the first sound generating unit such that, it generates a predetermined sound with the first frequency at a first time slot and a predetermined sound with the second frequency at a second time slot. Alternatively, the sound generation controlling unit can be adapted to control the first sound generating unit to concurrently generate the predetermined sounds with the first and second frequency. Generally, a suitable first frequency might refer to 2 kHz and a second frequency might refer to 5 kHz. In an embodiment, the sound generation controlling unit is adapted to control the sound generating units and the sound detecting units such that in the space different audio sensing zones are defined by assigning combinations of sound generating units and sound detecting units to each audio sensing zone, wherein the subject determination unit is adapted to determine a status and/or position of a subject independently for each defined audio sensing zone. Preferably, the sound generation controlling unit is adapted to control sound generating units assigned to different audio sensing zones such that the predetermined sounds generated by the sound generating units are generated subsequently. In this case, the sound generation controlling unit can be adapted to determine if a sound generating unit assigned to an audio sensing zone is currently generating a predetermined sound and to only control a sound generating unit assigned to another sound generating unit to generate the sound when no current predetermined sound is generated. Alternatively, the sound generation controlling unit is adapted to control sound generating units assigned to different audio sensing zones such that the predetermined sounds refer to different sounds, for instance, comprising different frequencies, and are generated by the sound generating units concurrently.

In an embodiment, the sound generation controlling unit is adapted to control the network devices such that groups of network devices are defined, wherein each group of network devices monitors a specific subject in the space and the sensing signal processing of each group is independent of the sensing signal processing of other groups. For instance, the groups can be predetermined based on knowledge on the environment and/or layout of the network. For example, network devices positioned at or near a seating area can be assigned to a group for monitoring the seating area, whereas network devices of the same network near a door in a receiving area can be assigned to a group for monitoring the door. Thus, the sensing systems can be individually adapted to the desired application such that its performance for the application can be optimized. In other embodiments, the sound generation controlling unit can also be adapted to use weights, as described above, to group the network devices into different groups. For example, the sensing signals of network devices that are not influenced by a status and/or position of an object that should be monitored can be provided for monitoring this object with a weight of zero and thus are not part of the group of network devices monitoring this object, whereas for monitoring another object the sensing signals of the same network device can be given a weight above zero such that they become part of the group of network devices monitoring this other object.

In an embodiment, the sound generation controlling unit is adapted to control the at least one sound generating unit to generate the predetermined sound as part of white noise or a music audio stream generated by the sound generating unit or to time the generation of the predetermined sound such that it is masked by an intermittent environmental noise. Generating the predetermined sound as part of white noise or a music audio stream allows to unobtrusively monitor a space in which persons are present. For example, the sound generation controlling unit can be adapted to determine a noisy moment to control the sound generating unit to generate the predetermined sound, e.g. the sound can be generated exactly during a word when someone is talking or when the HVAC fan is on, so that the predetermined sound is masked by this environmental sound. Moreover, the sound generation controlling unit can be adapted to control the sound generating unit such that the predetermined sound refers to a sharp pulse with limited amplitude such that it is less audible compared to other noise in the space. Preferably, the predetermined sound comprises a frequency which is different from the frequency of the environmental noise in order to avoid interference. The sound generation controlling unit can even be adapted to perform a baseline determination during moments when an environmental sound is present by utilizing a predetermined sound for the baseline determination with a different frequency than the frequency of the environmental noise. This has the advantage that a baseline can be determined in the presents of a person with a predetermined sound that would, without the environmental sound, be unacceptable for a person.

In an embodiment, the subject determination unit is adapted to determine an open or closed status of a door, window and/or furniture, and/or to determine a position of a furniture and/or a living being, and/or to determine a breathing rate, a body movement, a gait, a gesture, a vital sign, and/or activity of living being present in the space.

In an embodiment, at least one of the network devices comprises a lighting functionality. However, in other embodiments the network devices can also comprise other functionalities like entertainment functionalities, monitoring functionalities, etc.

In an aspect of the present invention, a network is presented, wherein the network comprises a) a plurality of network devices, wherein at least one network device comprises a sound generating unit and a plurality of the network devices comprises each a sound detecting unit, and b) a system for controlling a sound based sensing of subjects as described above.

In another aspect of the invention, a method for controlling a sound based sensing of subjects in a space is presented, wherein the sensing is performed by a network of network devices, wherein at least one network device comprises a sound generating unit and a plurality of network devices comprises each a sound detecting unit, wherein the network devices are distributed in the space, wherein the method comprises a) controlling the at least one sound generating unit to generate a predetermined sound and controlling the plurality of sound detecting units to detect the sound after a multi-channel propagation through at least a portion of the space and to generate a sensing signal indicative of the detected sound, wherein the at least one sound generating unit is located at a position in the room different from the position of the sound detecting units in the room, and b) determining a status and/or position of at least one subject in the space based on the plurality of sensing signals.

In another aspect of the invention, a computer program product for controlling a sound based sensing of subjects in a space is presented, wherein the computer program product comprises program code means for causing the system as described above to execute the method as described above.

It shall be understood that the system, the method, the computer program, and the network comprising this system, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

In a further aspect of the invention, the invention provides a lighting system for controlling a sound-based sensing of subjects in a space, wherein the sensing is performed by a network of network devices, wherein the network devices are lighting devices, wherein at least one network device comprises a sound generating unit and a plurality of network devices comprising each a sound detecting unit, wherein the network devices are distributed in the space, wherein the system comprises: a sound generation controlling unit for controlling the at least one sound generating unit to generate a predetermined sound and for controlling the plurality of sound detecting units to detect the sound after a multi-channel propagation through at least a portion of the space and to generate a sensing signal indicative of the detected sound, wherein the at least one sound generating unit is located at a position in the room different from the position of the sound detecting units in the room, and a subject determination unit for determining a status and/or position of at least one subject in the space based on the plurality of sensing signals. Said lighting devices may in embodiments be luminaires. For example, said luminaires may comprise a microphone and speaker.

### BRIEF DESCRIPTION OF THE DRAWINGS

In the following drawings:

FIG. 1 shows schematically and exemplarily an embodiment of a network comprising a system for controlling a sound-based sensing,

FIG. 2 shows schematically and exemplarily a flowchart of a method for controlling a sound-based sensing,

FIG. 3 shows schematically and exemplarily a distribution of a network comprising a system for controlling a sound-based sensing in a space,

FIG. 4 and FIG. 5 refer to experimental results of a sound-based sensing based on an embodiment of the invention, and

FIG. 6 and FIG. 7 show schematically and exemplarily optional extensions of the method for controlling a sound-based sensing.

### DETAILED DESCRIPTION OF EMBODIMENTS

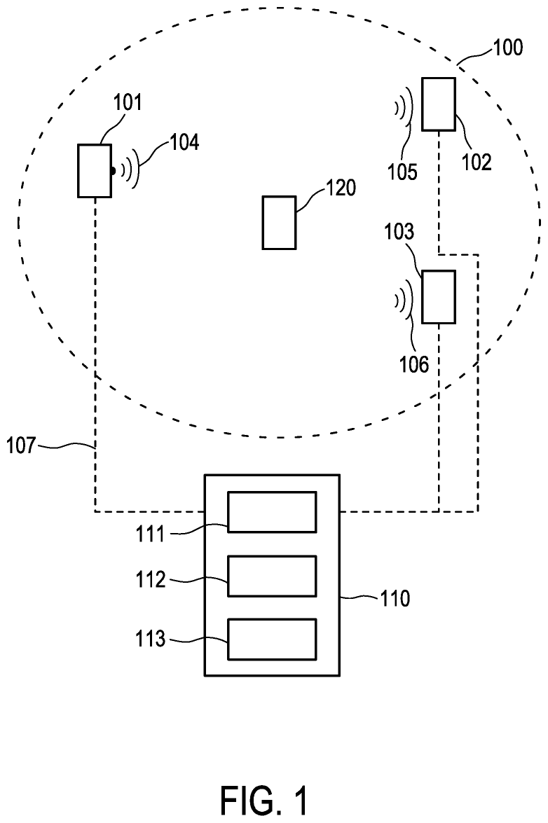

FIG. 1 shows schematically and exemplarily a network 100 comprising a system 110 for controlling a sound-based sensing of a subject 120. The network comprises in this example three network devices 101, 102, 103 that are adapted to communicate in a wired or wireless manner with each other to form the network 100 based on any known network protocol. The network 100 with the three network devices 101, 102, 103 is provided in an area or space comprising a subject 120 for which a status and/or position should be determined. Generally, network devices 101, 102, 103 are distributed in the area in which the network 100 is provided such that in particular two different network devices do not share the same location in this area.

The network device 101 comprises a sound generating unit that is adapted to generate a predetermined sound 104. The network devices 102, 103 each comprises a sound detecting unit that is adapted to detect a sound 105, 106 resulting from a propagation of the predetermined sound 104 through the space of the network 100 and in particular from an interaction of the predetermined sound 104 with the subject 120. Further, in this embodiment the network 100 comprises a system 110 for controlling a sound-based sensing performed by the network devices 101, 102, 103. In particular, in this exemplary embodiment the system 110 is provided as software and/or hardware of a device not referring to a network device, for instance, of a stand-alone device or an integrated device like a computing device, a handheld user device, a laptop, a personal computer, etc. However, in other embodiments the system 110 can be part of one of the network devices 101, 102, 103, for instance, can be provided inside the housing of one of the network devices 101, 102, 103 or can be distributed between the network devices 101, 102, 103, wherein in this case the system 110 is formed by the communication between the network devices 101, 102, 103.

In order to provide the controlling of the network devices 101, 102, 103, the system 110 and in particular, the sound generation controlling unit 110 is adapted to communicate in a wired or wireless manner with the network devices 101, 102, 103, for instance, through the connections 107 indicated by a dashed line in FIG. 1. The communication between the system 110 and the network devices 101, 102, 103 can be part of the general network communication but also can be different from the network communication, for instance, can use a different communication protocol than the network communication. In particular, the communication between the system 110 and the network devices 101, 102, 103 can be a wired communication, whereas the network communication can be a wireless communication or vice versa.

The system 110 comprises a sound generation controlling unit 111 and a subject determination unit 113 and optionally a baseline providing unit 112. The sound generation controlling unit 111 is adapted to control the network devices 101, 102, 103 to perform the sound-based sensing. In particular, the sound generation controlling unit 111 is adapted to control the sound generating unit of the network device 101 to generate the predetermined sound 104. Further, the sound generation controlling unit 111 is adapted to control the sound detecting units of the network devices 102, 103 to detect the sound after a multi-channel propagation through at least a part of the area in which the network 100 is provided and in particular after an interaction with the subject 120. The sound generation controlling unit 111 is then adapted to control the network devices 102, 103 to generate sensing signals that are indicative of the detected sounds 105, 106, respectively.

The subject determination unit 113 is adapted to determine a status and/or position of the subject 120 from the sensing signals provided by each of the network devices 102, 103. For instance, in one exemplary embodiment the system 110 can further comprise the baseline providing unit 112 that can be realized as a storage unit storing a plurality of baselines corresponding to different statuses and/or positions of the subject 120. In particular, during a calibration step the subject 120 can be placed at different positions in the area and can be provided in different statuses that should be identifiable by the subject determination unit 113. In each of the different positions and statuses in which the subject 120 is provided during the calibration step, the system can be adapted to perform a sound-based sensing, i.e. the sound generation controlling unit 111 can be adapted to control the sound generating unit of the network device 101 to generate the predetermined sound 104 and to control the sound detecting units of the network devices 102, 103 to detect the generated sound after its interaction with the subject 120 and to generate according sensing signals. Thus, during the calibration step for each status and/or position of the subject 120 that should be identifiable by the subject determination unit 113 corresponding sensing signals are generated, wherein the sensing signals for one status and/or position of the subject can be regarded as forming a baseline for this status and/or position of the subject 120. Such determined baselines can then be stored on a storage, wherein the baseline providing unit 112 is then adapted to retrieve these baselines from the storage.

The subject determination unit 113 can then compare the different provided baselines with the current sensing signals received from the network devices 102, 103. The comparison can be based on different characteristics of the sensing signals, for instance, on an amplitude, a frequency spectrum, etc. Moreover, the comparison can be based on a signal strength of the sensing signals and/or based on a channel state information of the sensing signals. The subject determination unit 113 can then be adapted to compare the sensing signals with the baseline to determine whether one or more of the signal characteristics fall within a predetermined range of the signal characteristics of the baseline. If this is the case, the subject determination unit 113 can be adapted to determine the status and/or position of the subject 120 as a status and/or position of the subject 120 corresponding to the baseline to which the current sensing signal is substantially similar. However, in other embodiments the subject determination unit 113 can also be provided with a trained machine learning algorithm such that the subject determination unit 113 can be adapted to utilize the machine learning algorithm to determine the status and/or position of the subject 120. For example, the trained machine learning algorithm can be trained during the calibration phase using the sensing signals determined during the calibration phase that in the above embodiment were regarded as baselines. These sensing signals can be provided together with a corresponding status and/or position of the subject to which they correspond as training data to the machine learning algorithm such that the machine learning algorithm learns to differentiate based on the sensing signals between the different statuses and/positions of the subject 120. The trained machine learning algorithm can then be provided and stored as hardware and/or software as part of the subject determination unit 113 such that it can be utilized by the subject determination unit 113. Generally, the machine learning algorithm can be trained to utilize directly the sensing signals as input and/or to utilize a signal strength and/or channel state information of the sensing signals as input for determining a status and/or position of the subject 120. More details of the different methods that can be utilized by the subject determination unit 113 for determining the status and/or position of the subject 120 will be explained together with the more detailed embodiments of the system 110 below.

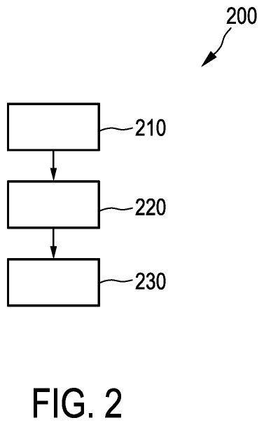

FIG. 2 shows schematically and exemplarily a method 200 for controlling a sound-based sensing of for instance a subject 120. The method comprises a step 210 of controlling at least one sound generating unit like the sound generating unit of the network device 101, to generate a predetermined sound 104. Further, the step 210 comprises a controlling of a plurality of sound detecting units, like the sound detecting units of network devices 102, 103, to detect the sound after a multi-channel propagation through at least a portion of the space or area in which the network 100 is provided and generating a sensing signal indicative of the detected sound. Optionally, the method 200 comprises a step 220 of providing one or more baselines indicative of sensing signals detected by the sound detecting units with respect to one or more predetermined statuses and/or positions of the subject 120. The method 200 comprises then a step 230 of determining a status and/or position of at least one subject 120 in the space based on the sensing signals optionally further taking into account the baselines provided in step 220.

An example of the system can employ a volumetric sound sensing involving a multitude of distributed microphones as sound detecting units to monitor the status of a door, window or desk. Generally, during a setup of the sensing system, for instance, by an installer, the audio sensing system can be trained, for instance, in a supervised way, for identifying, i.e. determining, different furniture statuses and/or positions. In particular, these statuses and/or positions can be deliberately physically set by the installer and by measuring the sensing signals for the different setups sensing signal characteristic thresholds for each status and/or position can be derived. Moreover, baselines or training data for a machine learning algorithm can also be provided by numerically modeling a sound propagation in the area, for instance, based on building information management data describing the room layout and the furniture arrangement.

In an exemplary embodiment, the sound generating unit can be utilized as a directional speaker to send a beam-formed directional audio signal as predetermined sound towards a target subject. In particular, the sound generating unit is adapted in this case to predominantly transmit the sound signal in a specific direction. The subject determination unit can then be adapted to recognize, for instance, based on calibration data, like baselines, obtained during the system setup, that an audio channel status information, i.e. relative signal strength of each of the audio multipath signals, is associated with a certain furniture status at this specific location.

Generally, it can be shown that any change of a status and/or position of a subject leads to a pronounced change in audio multipath signals within the room. Moreover, in addition, whenever a status and/or position of a subject changes, an integral audio sensing signal strength changes, as the amount of audio signals that can bleed to the outside of a room can be different such that less audio signals are reflected by the subject back to the sound detecting units referring, for instance, to microphones in the ceiling. As in this embodiment the audio signal is transmitted by the speaker on purpose directionally to the subject, the change in the multipath propagation pattern, i.e. the sensing signals being indicative of the multipath propagation of the sound signal, after any subject status and/or position change will be very pronounced.

Exemplarily, the following equations can be utilized to describe the propagation of the sound through the sensing space from one or more sound generating units to two or more sound detecting units. Assuming that M directional sound generating units are utilized in a room that beam-form the sound signals towards a subject in this case and that N sound detecting units detect the sound having been propagated through the space, the following equation can be utilized:

$$[ \begin{matrix}{y}_{0} ( t ) \\ … \\ {y}_{N - 1} ( t )\end{matrix} ] = [ \begin{matrix}{h}_{0 , 0} & … & {h}_{0 , M - 1} \\ … & … & … \\ {h}_{N - 1 , 0} & … & {h}_{N - 1 , M - 1}\end{matrix} ] [ \begin{matrix}{x}_{0} ( t ) {π}_{0} ( {ϕ}_{0} , {θ}_{0} ) \\ … \\ {x}_{M - 1} ( t ) {π}_{M - 1} ( {ϕ}_{M - 1} , {θ}_{M - 1} )\end{matrix} ] + [ \begin{matrix}{n}_{0} ( t ) \\ … \\ {n}_{M - 1} ( t )\end{matrix} ] ,$$

where xₘ(t) refers to the generated sound signal of the mth sound generating unit and πₘ(ϕₘ, θₘ) are the coefficients for the mth sound generating unit to beam-form the sound towards the subject, which depends on the function πₘ of azimuthal angle ϕₘ and elevational angle θₘ. Further, yₙ(t) refers to the sound detected by the nth sound detecting unit, i.e. to the sensing signal being indicative of this sound, {h_{n,m}} refer to the channel state information, i.e. channel state coefficients, provided in form of a channel state matrix, and nₘ(t) refers to the noise in the propagation path. Since the reflections of the sound at the subject change together with status and/or position changes of the subject, the channel state coefficients {h_{n,m}} will be quite different for the different statuses and/or positions. For example, if the subject refers to a door and the status of a door shall be detected, the channel state coefficients of {h_{n,m}} when the door is closed are generally higher than when the door is open, since most of the acoustic energy transmitted by the directional sound generating unit will bleed out of the room. Thus, in such an exemplary embodiment, the subject determination unit can be adapted to determine based on known algorithms the channel state information based on the sensing signals and the predetermined generated sound. An example of a method for determining channel state information of radiofrequency signals that can also be adapted to sound signals is provided by the article “From RSSI to CSI: Indoor localization via channel response.” Zheng Yang, et al., ACM Comput. Surv. 46, Article 25 (2013). The subject determination unit can then be adapted to monitor the channel state information for changes exceeding a predetermined threshold and if such a change has been detected, to compare the channel state information to one or more baselines for the channel state information corresponding to specific statuses and/or positions of the subject. However, the monitoring can also be omitted and the subject determination unit can be adapted to perform the comparison continuously or after predetermined time periods.

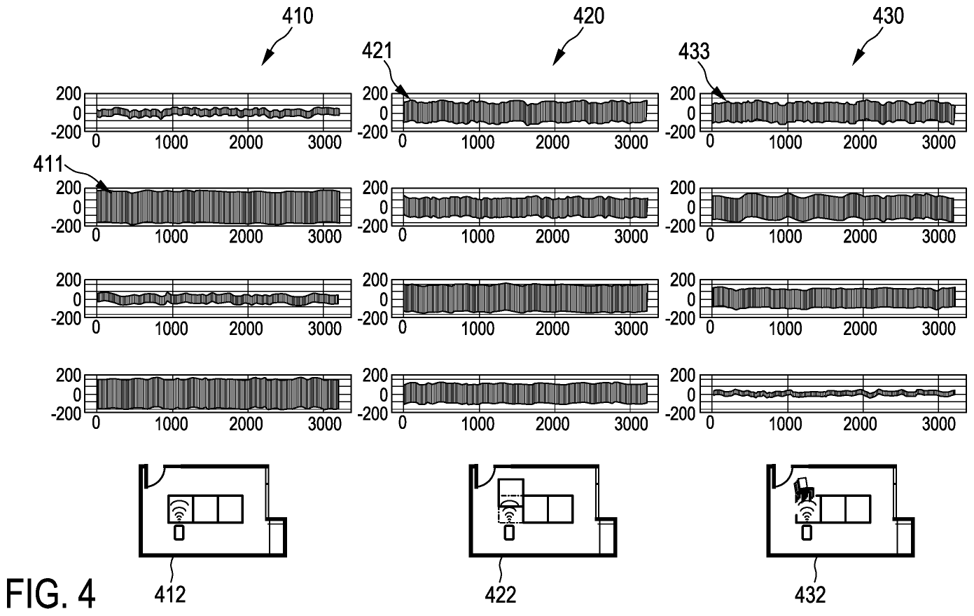

In another exemplary embodiment, omnidirectional sound generating units instead of the directional sound generating units described above can be utilized to generate as predetermined sound an omnidirectional sound. In this case, the subject determination unit can be adapted to assess an audio signal strength based on the sensing signals provided by the respective sound detecting units. Moreover, the subject determination unit can be adapted to apply increased weighting factors to those signal strengths provided by sound detecting units known to be most sensitive to specific changes of status and/or position of the subject. Different weighting factors may be used to look for status and/or position changes related to different subjects, for instance, to a first table at a far-end of a conference room and a second table normally located right next to a door. The received audio signal strength may be affected, for instance, by how wide a door is open or by the exact location of desk furniture. An experimental example for this will be given below with respect to FIG. 4.

Generally, the propagation of the sound signal can be described for this omnidirectional case as follows. For each pair of sound detecting units is the time of arrival τ_{q,i,j} proportional to the difference between the distance from the source s_{q} to the sound detecting units i and j at position rᵢ and rⱼ, leading to:

$${τ}_{q , i , j} = \frac{1}{c} {f}_{S} ( ‖ {s}_{q} - {r}_{i} ‖ - ‖ {s}_{q} - {r}_{j} ‖ ) ,$$

where fₛ is the sampling rate and c is the speed of sound. Then an energy yₙ(ϕ, θ), i.e. signal strength, for each sound detecting unit n towards the direction of the subject can be calculated as,

$${y}_{n} ( ϕ , θ ) = {\sum }_{i = 1}^{L} {\sum }_{j = ( i + 1 )}^{\frac{K}{2}} {X}_{i} [ k ] {{X}_{j} [ k ]}^{*} exp ( - \frac{j 2 {πτ}_{q , i , j}}{K} ) ,$$

where L is the number of detecting units, K is the number of detection time windows and Xᵢ[k] is the short time Fourier Transform of the ith sensing signal. By varying the source position s_{q} in the space, an energy from a certain direction can be calculated leading to:

$$[ \begin{matrix}{y}_{0} ( t ) \\ … \\ {y}_{N - 1} ( t )\end{matrix} ] = [ \begin{matrix}{h}_{0 , 0} & … & {h}_{0 , M - 1} \\ … & … & … \\ {h}_{N - 1 , 0} & … & {h}_{N - 1 , M - 1}\end{matrix} ] [ \begin{matrix}{x}_{0} ( t ) \\ … \\ {x}_{N - 1} ( t )\end{matrix} ] + [ \begin{matrix}{n}_{0} ( t ) \\ … \\ {n}_{N - 1} ( t )\end{matrix} ] ,$$

where also in this case xₘ(t) refers to the generated sound signal of the mth sound generating unit, yₙ(t) refers to the sound detected by the nth sound detecting unit, i.e. to the sensing signal being indicative of this sound, {h_{n,m}} refer to the channel state information, i.e. channel state coefficients, provided in form of a channel state matrix, and nₘ(t) refers to the noise in the propagation path. Thus, also in this case the subject determination unit can be adapted to utilize the channel state information as already described above. However, also the signal strength can directly be utilized for determining the status and/or position of the subject.

The previous two embodiments utilize the integral, i.e. non directional, received signal strength as sensing signal at the sound detecting unit. In another embodiment, an omnidirectional sound generating unit providing as predetermined sound an omnidirectional sound can be used in combination with sound detecting units that comprise a detection array, for example, a microphone array, embedded, for instance, in each luminaire in a room. Due to the detector array, the sound detecting units can now capture the respective audio channel state information for each of the audio multipaths between the sound generating unit, e.g. the transmitting speaker, and sound detecting unit directly as sensing signal. Hence, similar to WiFi channel state information based sensing, the audio sensing system now can assess each of the audio paths separately for signs of a changed subject setup. Preferably, the detector array of each detecting unit is configured such that the audio sensing is most sensitive to changes in the direction of the subject. For example, if a desk is present, this specific subset of audio multipath channels received by the detector array will be altered compared to the case when the specific desk is absent from the room.

In a further embodiment, it is preferred to combine a beam-formed, i.e. directional, predetermined sound and a received sound beam-forming, i.e. a detector array at the detecting unit. Such an embodiment has the advantage of further improving the detection accuracy of the sensing system.

Generally, in all above described embodiments the sound generating unit and sound detecting unit are not co-located but are embedded in different network devices like different luminaires or network switches. Optionally, the audio signal for the sensing, i.e. the predetermined sound, can be embedded in white noise or be outside of the audible range, e.g. greater than 16 kHz. To reduce the interference with people, initially non-audible sound ranges may be employed for the predetermined sound, and upon suspecting an event an audible sound sensing using an audible predetermined sound may be employed to verify the detection event. In many use cases, it is preferred to perform audio sensing only if the room is vacant, e.g. after a meeting ended in a conference room, and hence audible audio-sensing signal as predetermined sound can be used. Alternatively, the predetermined sound can be added to existing audio streams in the building, such as a retail soundscape, as an audio sensing watermark.

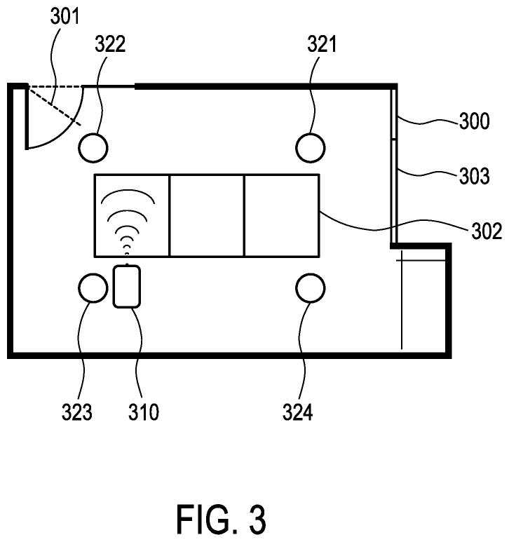

In the following, a detailed example will be discussed with respect to an experimental setting as shown schematically in FIG. 3. In this experimental setup, a sound generating unit 310, four sound detecting units integrated into luminaires 321, 322, 323, 324, an open door 301, three desk elements 302, chairs (not shown) and a closed window 303 are provided in a room 300. In an example, the open and close status of the door 301 shall be determined. For this case, a baseline for each status is provided, for instance, by the baseline providing unit, by modelling the values for the channel state information {h_{n,m}} for each status as

p(h_{n,m}|door status=0,1)=N(H,Σ|door status=0, 1),

where N(H,Σ) means the normal distribution with the channel state matrix H and variance matrix Σ. A threshold δₖ for each channel state information for distinguishing between the two statuses of the door can be determined, for instance, as

$${δ}_{0 , … , NM - 1} = argmax \frac{N ( H , Σ \vert door status = 1 )}{N ( H , Σ \vert door status = 0 )} .$$

The threshold can then be normalized based on the mean value of H and by stacking the matrix to a vector, leading to

ηₖ=δₖ/H̅ₖ̅′

where H̅ₖ̅ is the mean value of channel state information values when the door is closed. The such determined threshold can then be utilized, for instance, by the subject determination unit to decide if the door is open or not by comparing the channel state information determined from the sensing signals with the threshold according to

sum(δₖ/H̅ₖ̅>ηₖ,0, . . . ,MN−1)≥MN/2.

In a simple example, a statistical method may be used to detect a change in the subject status and/or position when comparing the sensing signals with the threshold. For instance, the subject determination unit of the audio sensing system may count how many channels, i.e. sensing signals, show channel state information values larger than the normalized threshold. If more than half of the channels are above the threshold, the subject determination unit can be adapted to decide that the door is closed. With such a simple statistical method, the audio sensing performance depends on how many sound detecting units are available in the space, although saturation will occur if the spacing between the detecting units is beyond a certain distance threshold, as lack of audio coverage limits per design the audio sensing capacity.

In the following, some experimental results for the sound-based sensing using a system with a layout as shown in FIG. 3 and described above will be provided. In this experiment, the predetermined sound refers to a simple, constant 1 kHz tone. However, alternatively also a simple, low-cost single-tone audio transmitting device from a children's toy can be used as sound generating device. In particular, such very affordable detecting units can also be integrated into a sensor bundle present in a smart luminaire, i.e. can be integrated into each network device, in a room. Such an arrangement with a sound generating unit in each network device allows to further increase sophistication of the audio sensing. For example, in this case a first sound generating unit can emit a first single tone while all other sound detecting units in the room listen to it, subsequently, the 2^{nd} and 3^{rd} sound generating units can take turns to generate a sound, and so on. Similar to radiofrequency sensing, a token may be used to decide which of the network devices is to transmit a sound signal and which ones are to listen at a given moment.

FIG. 4 shows the audio wave forms 411, i.e. sensing signals, from a series of experiments. In a first step, a baseline is established describing the nominal space status leading to the sensing signals shown in section 410 of FIG. 4. In this experiment, the baseline refers to a status of an empty room 412, i.e. a room without persons present. Subsequently, the left table in the room was rearranged about 1 m towards the door as shown in the schematic room 422 and a second audio sensing was performed leading to sensing signals 421 as shown in section 420. Subsequently, a third measurement was performed aiming at detecting a status change of the distribution of chairs within the room, in particular, with a stacking of chairs, as shown in the schematic room 432. The measured sensing signals 433 for this situation are provided in section 430. For all cases, the audio data was collected for two minutes for each of the different room statuses. FIG. 4 shows that clearly different audio sensing signals can be observed between the three states of the room, as illustrated by distinctly different combinations of the strength of the audio sensing signals measured at the four luminaire-integrated detecting unit locations. For instance, in the “move the table by one meter” situation in section 420, the detecting unit 323 detects a sound with a high signal strength due to the multiple paths taken by the sound signal, while for the baseline situation in section 410 the detecting unit 323 observes only a sound with a low signal strength. On the other hand, the detecting unit 322 detects a sound with a moderate signal strength in section 420, while in the baseline measurement a high strength was detected.

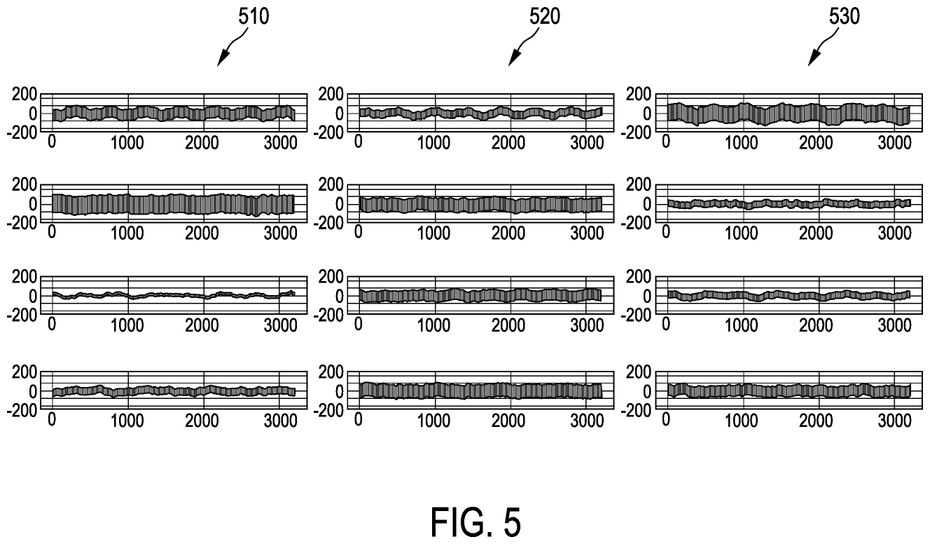

In another test, three different door statuses were measured: 1) closed, 2) half-closed, and 3) open. Again, audio data, i.e. sensing signals, for two minutes for each door status where detected, similar as described above. As shown in FIG. 5, also for this test distinctly different signal strengths of the audio signals, i.e. sensing signals, at the four luminaire-integrated detecting units were observed. For instance, in the closed-door position shown in section 510, detecting unit 321 detects a sensing signal with a moderate signal strength, while when the door is open, as shown in section 530, detecting unit 321 observes a sensing signal with a higher signal strength and for a intermediate state of the door, shown in section 520, the sensing signal is lower the for all the other states. The open-door status might cause a constructive overlapping between multiple paths due to reflection or scattering. On the other hand, sensor 322 detects a sound with low signal strength due to the multiple paths when the door is open.

In an embodiment, the subject determination unit can be adapted to determine a status and/or position of the subject based on measurements, for instance, the test measurements above, by employing a machine learning algorithm. A general neural network model with two or more layers using a softmax activity function at the output layer can be advantageously applied to classify the different statuses and/or positions of a subject, for instance, of a door or a general furniture, using the sensing signals as input. For example, it has been shown that an according simple four-layer machine learning model can be employed. Preferably, the input is simply defined as the sensing signal energy for each sensing signal, for instance, for a time window of 1000 samples, i.e. 62.5 ms. During the training of the machine learning model, the sensing signal energy for each sensing signal measured for different room statuses can be provided together with the information on the corresponding status as input to the machine learning algorithm. After the training, the machine learning algorithm can then differentiate the different statuses based on the signal energy for each sensing signal as input. Using the experimental data shown above as training data, such a machine learning algorithm obtains 100% accuracy for determining either door status classification or space status classification using clean sensing signals, i.e. signals measured without an interference with other noise sources present in the space. If audio sensing signals deliberately interfered by human speech or laptop fan noise where provided as input to the machine learning algorithm as described above, the accuracy would decrease to about 80%. Hence, it is preferred that the subject determination unit is further adapted to filter the sensing signals in order to suppress the impact of interfering sounds. Alternatively and preferably, the sensing system can be adapted to perform the audio sensing of furniture as subject if the room is known to be vacant. In summary, the experiments and the performance of the above described machine learning model shows that audio channel status information can be used to monitor a subject status and/or position. Hence, the proposed audio sensing system based on passive sensing methods works in practice.

In the following, some possible optional features of the system will be described that can be combined with any of the above described embodiments. In an embodiment, the baseline providing unit is adapted to periodically provide new sensing baselines, for instance, based on periodically performed baseline measurements. The refreshing of the baselines is advantageous to account for hardware aging in the sound generating unit and sound detecting units. For instance, every night the system can compare the unoccupied room audio-sensing signals against the baseline, wherein if a drastic signal change like a drastic signal strength or channel state information state change is observed, the creation of a new baseline is triggered and the new baseline is generated over the subsequent five nights and provided as new baseline.

In an embodiment, if drastic day to day changes in the audio sensing signals are observed, which are beyond a door/window status change or a shifting of furniture, the system can be adapted to notify a user like a facility manager to check out the room for abnormalities.

In a preferred embodiment, the baselines for closed window situations are preferably generated at night when all the windows in an office typically are closed. In this case, before proceeding with a night-time audio-sensing calibration procedure to determine a baseline, it is important to first assess whether the office occupants/cleaners have unintentionally left one of the doors or windows open. The system can be adapted to only determine the baseline if it has been verified, for instance, by a user input, that all doors and windows are closed.

In an embodiment, the baseline providing unit can be adapted to compare the sensing signals collected during a multitude of nights to recognize if the baseline has changed rapidly over the last day or days. If the baseline has changed rapidly, the baseline providing unit can be adapted to conclude that it is required to run the self-learning algorithm to deduce what actually has changed in the room, e.g. a table has been moved to another location while another table remained in place, and to subsequently report these findings and/or to determine a new baseline based on these findings.

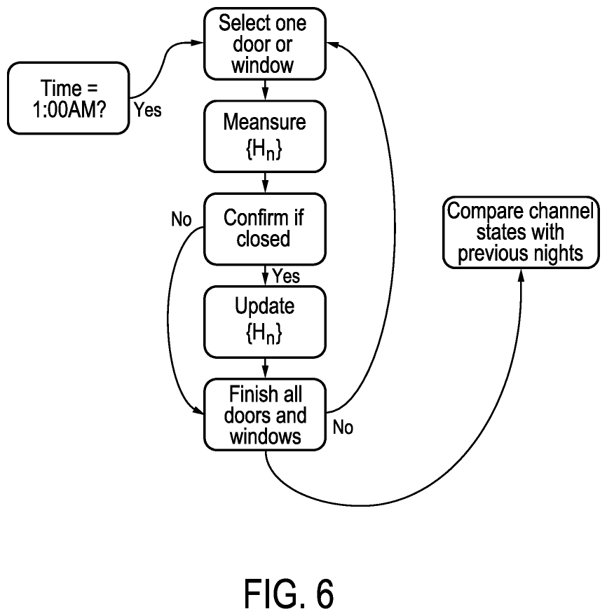

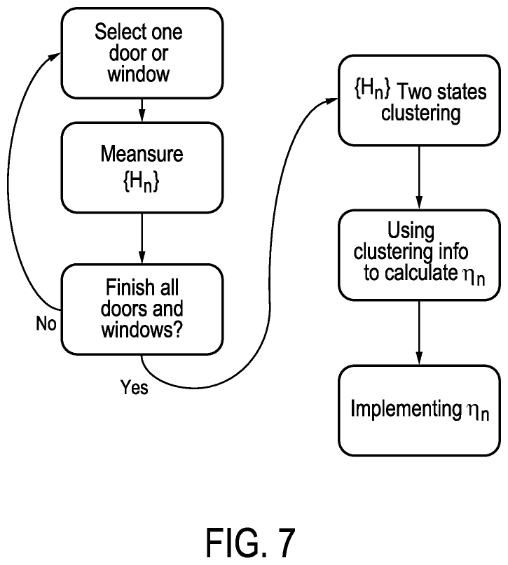

FIG. 6 shows an exemplary block diagram illustrating a possible decision making process whether a self-calibration of the sensing system is required. If the decision process shown in FIG. 6 comes to the conclusion that a self-calibration is required, the sensing system can be adapted to execute a self-learning calibration algorithm as exemplary described in FIG. 7. For example, as shown in FIG. 6 a test measurement can be performed every day at a certain time, for instance, at a night time and the results of test measurements of different nights can be compared. If the result of a current test measurement differentiates from the result of previous test measurements, it is indicated that an object in the space has changed its status. However, if the change in the test measurement can be observed also in a following night, the sensing system can be adapted to determine that the object has permanently changed its status in the room such that a new baseline determination has to be performed. For determining a new baseline, in particular, for determining a new threshold ηₖ, as described above, a method as schematically and exemplarily shown in FIG. 7 can be utilized. In this method, for each subject, for example, for each door and/or window of a room, the channel state information is determined. Then a calculation in accordance with the calculation described with respect to the example of FIG. 3 can be utilized for calculating the threshold ηₖ, wherein in FIG. 4 the calculating of the ratio of the channel state information for different statuses of the subject, as explained in detail above, is referred to a clustering of the channel state information. However, the clustering can refer to any known method of determining clusters of values that refer to different statuses of a system and then determining one or more thresholds ηₖ for differentiating each cluster, i.e. each status, from other clusters. The threshold ηₖ can then be implemented as new threshold determined based on the new baselines into the determination of the position and/or status of the subject.

Optionally, the system can be adapted to determine during calibration also whether even a closed door or window causes some audio leakage to the outside of the room as is the case, for instance, when a door leaves a significant air gap to the outside of the room. In this case, a threshold can be defined by calculating a probability as

Prob(h_{n,m}|H,Σdoor status−1)<1−s

For example, even if it is detected that the door is closed, but the probability is determined to be less than the threshold 1−ε, the system can be adapted to notify a user that an audio leakage might be possibly indicating a mechanical problem of the window/door, e.g. that a window no longer closes properly or is not sealed well, which may impact HVAC energy efficiency and building safety or lead for intelligible speech leaking from one room into another room and disturbing other office workers. For this use case of checking proper sealing of doors or windows, it is preferred that a fine grained audio sensing is used requiring a more elaborate calibration step during system setup.

Alternative to using a lighting-infrastructure with integrated sound detecting units, as described above, for instance, also a multitude of existing smart speaker devices, e.g. Amazon Echo, can be used to as network devices.

Generally, it is known that standing audio waves can be formed in a room, for instance, an acoustical designer may deliberately add diffusion elements, e.g. a rough brick wall, to a building space when creating a home theatre for an audiophile customer. The added diffusion elements prevent the formation of unwanted audio standing waves in the home theatre. However, unlike in a millionaire's home theatre, many normal rooms, e.g. office or conference rooms, have many smooth surfaces such as glass, smooth walls, stone floors, etc., which are known to create more echoes and reflections and thereby create standing audio waves in the room. As a room with all-absorptive surfaces is not going to be a good-sounding room, even a high-end home theatre uses a balance of diffusion and absorption to achieve a good audio environment. Consequently, in practice all type of rooms exhibits a suitable acoustic environment, i.e. includes some standing audio waves, for the invention as described above.

In this invention, it is proposed to preferably use a lighting system embedded with a multitude of microphone sensors as detecting units distributed across the room to monitor a subject status and/or position. The sound generating unit can also be integrated within a subset of the lighting fixtures. For instance, very affordable ultra-cheap audio-transmission elements, which are capable of sending just one beep at a pre-selected fixed frequency, are readily available from children's toys at very low cost and can be utilized as sound generating unit. If a more advanced programmable audio frequency as predetermined sound is desired for further improving the audio sensing performance, a range of suitable, very affordable programmable speaker products are available that can be used as sound generating unit.

Prior art furniture-position and door/window monitoring systems in summary suffer either from high cost for dedicated security devices or high cost of cloud-based AI processing. For example, BLE/UWB positioning tags are costly and required edge computing servers. In addition, the tags are usually battery powered with limited lifetime. Moreover, for prior art home monitoring solutions relying on sound pattern-based event recognition, for instance, monitoring the noise associated with the opening and closing of a door, either a permanent cloud connection is needed or a high-end device has to be installed on-premise which is capable of a deep-learning based audio recognition approach. Further, if an on-premise sound event-signature recognition solution is desired, a high cost for the on-premise hardware is required. Generally, prior art audio sensing systems are usually focused on detecting change events, e.g. a glass breaking event, which requires a high-end audio analytics processor.

To avoid the above mentioned drawbacks of the prior art, it its proposed in this invention, inter alia, to utilize a distributed microphone grid, i.e. sound detecting unit grid, integrated within luminaires, in order to monitor furniture-presence/position within an office room as well as the door/window status. The proposed audio sensing solution is capable of monitoring the true status of the furniture, unlike prior art which relies on catching a status change event. Preferably, such a determined status and/or position of furniture in a room, for instance, in an office, can be provided to a space optimization application, e.g. for hot desking purposes in a workplace experience app such as Comfy. In a preferred embodiment, a directional audio solution applying a directional “sound curtain” to periodically scan the door and windows status, as well as verifying that changeable office desks are still at their desired positions can be performed. The proposed audio sensing is preferably performed when the room is known to be unoccupied by humans.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the controlling of the sound detecting unit or the sound generating unit, the providing of the baseline, the determining of the status and/or position of the subject, et cetera, performed by one or several units or devices can be performed by any other number of units or devices. These procedures can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The present invention refers to a system for controlling a sound-based sensing of subjects in a space, wherein the sensing is performed by a network of network devices distributed in the space. At least one network device comprises a generating unit and a plurality of network devices located differently from the generating unit comprising a detecting unit. The system comprises a controlling unit for controlling the at least one generating unit to generate a predetermined sound and the plurality of detecting units to detect the sound after a multi-channel propagation through at least a portion of the space and to generate a sensing signal indicative of the detected sound, and a determination unit for determining a status and/or position of at least one subject in the space based on the plurality of sensing signals.

1. A system for controlling a sound-based sensing of subjects in a space, wherein the sensing is performed by a network of network devices, wherein at least one network device comprises a sound generating unit and a plurality of network devices comprising each a sound detecting unit, wherein the network devices are distributed in the space, wherein the system comprises:
a sound generation controlling unit for controlling the at least one sound generating unit to generate a predetermined sound and for controlling the plurality of sound detecting units to detect the sound after a multi-channel propagation through at least a portion of the space and to generate a sensing signal indicative of the detected sound, wherein the at least one sound generating unit is located at a position in the room different from the position of the sound detecting units in the room, and a subject determination unit for determining a status and/or position of at least one subject in the space based on the plurality of sensing signals;
a baseline providing unit for providing a baseline indicative of sensing signals detected by the sound detecting units with respect to at least one predetermined status and/or position of the at least one subject in the space, wherein the subject determination unit is adapted to determine a status and/or position of the at least one subject further based on the provided baseline;
wherein a plurality of the network devices comprises a sound generating unit;
wherein the sound generation controlling unit is adapted to control each of the sound generating units of the network devices to generate a predetermined sound subsequent to each other, and the sound detecting units of all other network devices to detect, respectively, the subsequently generated sounds.

2. The system according to claim 1, wherein the status and/or position is determined based on i) the signal strength of the plurality of detected sensing signals and/or based on ii) channel state information derived from the plurality of detected sensing signals and the predetermined generated sound.

3. The system according to claim 1, wherein the sound generation controlling unit is adapted such that the sound generating unit generates the predetermined sound as a directed sound, wherein the directed sound is directed to the at least one subject.

4. The system according to claim 1, wherein the sound generation controlling unit is adapted such that the sound generating unit generates the predetermined sound as an omnidirectional sound.

5. The system according to claim 4, wherein each sound detecting unit comprises a sound detection array such that the plurality of sensing signals are each indicative of a direction from which the detected sound has reached the detection array, wherein the subject determination unit is adapted to determine the status and/or position of the subject further based on the direction information provided by each sensing signal.

6. The system according to claim 1, wherein each network device comprises a sound detecting unit and a sound generating unit, wherein the sound generation controlling unit is adapted to control the sound generating units of the network devices to generate a predetermined sound and the sound detecting units of all other network devices to detect the generated sounds such that for each sound generated by a different sound generating unit a plurality of detected sensing signals are generated, wherein the status and/or position of the subject is determined based on each of the plurality of audio sensing signals.

7. The system according to claim 1, wherein the sound generation controlling unit is adapted to control the sound generating units of the network devices to subsequently generate different predetermined sounds and the sound detecting units of all other network devices to detect the subsequently generated different sounds.

8. (canceled)

9. The system according to claim 1, wherein the subject determination unit is adapted to determine an open or closed status of a door, window and/or furniture, and/or to determine a position of a furniture and/or a living being, and/or to determine a breathing rate, a body movement, a gait, a gesture, a vital sign and/or activity of living being present in the space.

10. The system according to claim 1, wherein at least one of the network devices comprises a lighting functionality.

11. A network comprising:
a plurality of network devices, wherein at least one network device comprises a sound generating unit and a plurality of the network devices comprises a sound detecting unit, and
a system for controlling a sound based sensing of objects according to claim 1.

12. A method for controlling a sound based sensing of subjects in a space, wherein the sensing is performed by a network of network devices, wherein at least one network device comprises a sound generating unit and a plurality of network devices comprises each a sound detection unit, wherein the network devices are distributed in the space, wherein a plurality of the network devices comprises a sound generating unit, wherein the method comprises:
controlling each of the sound generating units to generate a predetermined sound subsequent to each other and controlling the sound detecting units of all other network devices to detect, respectively, the subsequently generated sounds after a multi-channel propagation through at least a portion of the space and to generate a sensing signal indicative of the detected sound, wherein the at least one sound generating unit is located at a position in the room different from the position of the sound detecting units in the room, and
determining a status and/or position of at least one subject in the space based on the plurality of sensing signals;
providing a baseline indicative of sensing signals detected by the sound detecting units with respect to at least one predetermined status and/or position of the at least one subject in the space, wherein the subject determination unit is adapted to determine a status and/or position of the at least one subject further based on the provided baseline

13. A computer program product for controlling a sound based sensing of subjects in a space, wherein the computer program product comprises program code means for causing the system to execute the method according to claim 12.
